(19) United States
(12) Patent Application Publication
(10) Pub. No.: US 2021/0281480 A1
(43) Pub. Date: Sep. 9, 2021

(54) DEFINING AND IMPLEMENTING AN EPHEMERAL CONFIGURATION STATE FOR A NETWORK DEVICE

(71) Applicant: Microsoft Technology Licensing, LLC, Redmond, WA (US)

(72) Inventors: Alberto GONZALEZ PRIETO, Santa Clara, CA (US); Mark HENNESSY, Kirkland, WA (US); Anish Sagar NARSIAN, Cupertino, CA (US)

(21) Appl. No.: 16/812,031

(22) Filed: Mar. 6, 2020

(51) Int. Cl. H04L 12/24; H04L 29/06; H04L 29/08; H04L 12/26

(52) U.S. Cl. CPC H04L 41/0826; H04L 41/0213; H04L 41/12; H04L 67/1023; H04L 41/145; H04L 67/16; H04L 43/022; H04L 67/42

(57) ABSTRACT

The present disclosure relates to systems, methods, and computer-readable media for defining and implementing an ephemeral portion of a configuration state on a network device that does not persist upon coming up after experiencing a power loss event of the network device. For example, systems disclosed herein include receiving information indicating commands or policies of a configuration state that may be defined as ephemeral. The systems disclosed herein include generating and maintaining an ephemeral definition that includes modes, XPaths, and other identifiers of characteristics and specific command nodes within a hierarchical structure of commands that should be treated as ephemeral when rebooting the network device. The systems described herein provide an effective and convenient tool for defining an ephemeral portion of a configuration state that does not persist when the network device recovers from a power loss event.

### BACKGROUND

A networked computing system (e.g., a cloud computing system, data center, enterprise network) refers to a collection of computing devices capable of providing remote services and resources. As an example, modern computing infrastructures often include a collection of physical server devices organized in a hierarchical structure including computing zones, virtual local area networks (VLANs), racks, fault domains, etc. These computing infrastructures may provide computing resources to users including a variety of processors, memory, and storage devices capable of providing different services to users of the networked computing system. Moreover, devices that make up computing infrastructures may include a wide variety of devices such as computing nodes, storage devices, routers, switches, firewalls, load balancers, storage arrays, and other types of devices.

Each network device generally includes a configuration state that defines rules associated with how the device operates and how data is processed and communicated within the computing system. For example, a configuration state may include rules governing whether a particular device should provide access to various sources and/or whether information packets should be provided to various destinations. As another example, a configuration state may define protocols that a particular device supports. Conventional methods for generating and/or managing configuration states, however, suffer from a number of problems and drawbacks, particularly when attempting to distinguish between persistent and non-persistent elements of the configuration state.

For example, many conventional devices store different elements of a configuration state on different data stores. Many conventional systems may include a non-ephemeral (e.g., persistent) datastore and an ephemeral (e.g., non-persistent) datastore to maintain respective elements of a configuration system. In this example, modifying a configuration state often involves manually transferring commands from one datastore to another in a time-consuming and error-prone process. Indeed, modifying configuration states in this way often results in dependency problems and coding errors that result in the network device failing to operate correctly.

As another example, many conventional devices hardcode a configuration state when designing the device. While hardcoding a configuration state may provide a very stable structure of rules for a network device, hardcoding commands at design does not provide flexibility in changing commands and/or modifying how a network device operates within a networked computing infrastructure. As a result, these devices provide limited flexibility and/or utility in performing various functions within a networking computing infrastructure, such as a cloud computing system or other network of computing devices.

These and other problems exist with regard to implementing and maintaining configuration states on network devices.

### BRIEF DESCRIPTION OF THE DRAWINGS

FIG. 1 illustrates an example environment including an implementation of a configuration management system for defining an ephemeral portion of a configuration state in accordance with one or more embodiments.

FIG. 2 illustrates an example ephemeral definition indicating ephemeral portions of a command tree representative of a configuration state in accordance with one or more embodiments.

FIG. 3 illustrates another example ephemeral definition indicating ephemeral portions of a command tree representative of a configuration state in accordance with one or more embodiments.

FIG. 4 illustrates an example timeline associated with restoring a configuration state after a network device goes down in accordance with one or more embodiments.

FIG. 5 illustrate an example series of acts for implementing a configuration management system for defining an ephemeral portion of a configuration state in accordance with one or more embodiments.

FIG. 6 illustrates certain components that may be included within a computer system (e.g., a network device).

### DETAILED DESCRIPTION

The present disclosure relates to systems, methods, and computer-readable media for defining an ephemeral portion of a configuration state for a network device that does not persist upon resetting, rebooting, or otherwise bringing the network device back up after going down. In particular, as will be discussed in further detail below, a configuration management system may facilitate receiving information identifying one or more elements (e.g., commands) of a configuration state to include within an ephemeral definition for the configuration state. The ephemeral definition may define, identify, or otherwise point to specific commands and sub-commands within a hierarchical model of commands that make up the configuration state for the network device. As will be discussed in further detail below, the configuration management system includes features and functionality that provides flexibility in identifying ephemeral portions of a configuration state while enabling the network device to operate securely and reliably within the structure of a network of computing devices prior to and after performing a reboot of the network device.

For example, and as will be discussed in further detail below, a configuration management system (e.g., on a network device) may maintain a configuration state for a network device on a cloud computing system (or other network of computing devices) that includes a hierarchical model of commands that affect how the network device operates within the cloud computing system. The configuration management system may further receive an identification of commands from the hierarchical model to be defined as an ephemeral portion of the configuration state. The configuration management system may maintain an ephemeral definition designating the one or more commands and any sub-commands (e.g., within the hierarchical structure of commands) as an ephemeral portion of the configuration state. In response to performing a reboot, the configuration management system can utilize the ephemeral definition to recover a reboot or default configuration state including a persistent or otherwise non-ephemeral portion of the configuration state.

The present disclosure includes a number of practical applications that provide benefits and/or solve problems associated with configuration systems and techniques for maintaining and implementing a configuration state having an ephemeral portion on a network device. In particular, the systems described herein provide flexibility in identifying commands of a hierarchical model of commands that define a configuration state. Indeed, whether the hierarchical model refers to an extensible markup language (XML) path (XPath) data model or a structure of modes defined by a command line interface (CLI), the configuration management system provides a convenient and flexible tool that enables an individual having access to an exposed hierarchical structure to identify commands (e.g., modes, XPaths) of the structure and designate any number of commands to be treated as ephemeral elements of the configuration state.

In addition, by generating and maintaining an ephemeral definition that defines or points to selective commands within the configuration state, the configuration management system provides a flexible way to identify an ephemeral portion of a configuration system without maintaining respective portions of the configuration state on different data stores. Indeed, the entire configuration state including both non-ephemeral commands and ephemeral commands (as defined by the ephemeral definition) may be stored or otherwise maintained within the same data file and/or data store. This greatly simplifies the process of creating, modifying, and otherwise maintaining an ephemeral portion of the configuration state over conventional systems in which changes are made manually to ephemeral and non-ephemeral portions of a configuration state stored on different data stores.

In addition to providing flexibility in modifying and otherwise maintaining an ephemeral portion of a configuration state, the configuration management system further reduces instances in which the network device fails to operate correctly as a result of human error in modifying a configuration state. Indeed, where designating or modifying an ephemeral portion of a configuration state in conventional systems would typically involve manually moving a configuration state (e.g., selective portions of the configuration state) from one datastore to another while ensuring that dependencies are not violated and that movement of the configuration state is neither over nor under inclusive, the configuration management system described herein provides a consistent and uniform technique for identifying commands to be designated as an ephemeral portion of the configuration state. This uniform identification mechanism significantly prevents or otherwise reduces instances of the network device becoming inoperable or insecure as a result of a change to the ephemeral portion of the configuration data.

Moreover, and as will be discussed in further detail below, the configuration management system provides additional features and functionality that provide improvements over conventional configuration systems. For example, an ephemeral definition may further include metadata identifiers that enhances flexibility of identifying commands within the hierarchical structure of commands that should be considered as ephemeral. In addition, the configuration management system may restore a default or reboot configuration that reverts to a more restrictive implementation of the configuration state for a period of time until receiving a current configuration state. In this way, the configuration management system can ensure security of the network device between when the network device goes down and when the network device receives a current iteration of the configuration state, even where the configuration state may have been modified or updated between the network device going down and being rebooted.

As illustrated in the foregoing discussion, the present disclosure utilizes a variety of terms to describe features and advantages of a configuration management system within a variety of computing environments. Additional detail will now be provided regarding the meaning of some of these terms. For instance, as used herein, a “network device” may refer to any computing device within an environment of a cloud computing system (or other network of devices). Indeed, a network device may refer to any of a variety of different types of devices that perform various functions on a private or public cloud computing system. By way of example and not limitation, a network device may refer to computing nodes, enterprise devices, storage devices, routers, switches, firewalls, load balancers, and storage arrays. Each network device on the cloud computing system may include a configuration state implemented thereon. Each configuration state may be unique to each specific device.

As used herein, a “configuration state” may refer generally to any information indicating rules and commands associated with operation of a corresponding network device. In one or more embodiments described herein, a configuration state specifically refers to a hierarchical model of commands (e.g., rules, policies) that govern how a network device communicates with other devices (e.g., within or outside a cloud computing system) and/or how the network device generally operates. For example, a configuration state may include commands indicating acceptable formats or communication protocols that a network device may use when receiving and/or transmitting data packets (e.g., information packets, network packets) to other devices. A configuration state may additionally include commands indicating whether the network device is permitted to receive and/or transmit data packets to select locations (e.g., source addresses and/or destination addresses). The configuration state may further include policies associated with how data is processed when received and/or prior to being transmitted by the network device. Moreover, a configuration state may include metadata associated with respective commands indicating information about each command such as a user who created or modified a command or time when a command was created. Metadata may also indicate dependencies between the command and other commands within the configuration state and any information associated with modifications to the respective commands.

As mentioned above, and as will be discussed by way of example herein, a configuration state may be modeled or accessible in a variety of ways. In one or more embodiments described herein, a configuration state includes a hierarchical model of commands organized using a tree structure (e.g., a configuration tree). For example, the configuration state may refer to a data model instantiated using extensible markup language (XML) (e.g., an XML data model instantiation). In this example, subsets of the configuration state can be referenced using XPaths. The data model may be defined using a variety of data model languages, such as a Yet Another Next Generation (YANG) or JavaScript Object Notation (JSON). As another example, the configuration state may include a command-line interface (CLI) based model including a list of commands (e.g., partial commands) organized in a hierarchy of modes. Similar to the data model, the CLI-based model may include a hierarchical structure of modes (e.g., commands, partial commands, sub-commands) that define how the network device operates (e.g., within a cloud computing system).

As mentioned above, and as will be discussed in further detail herein, a configuration state may include an ephemeral portion and a non-ephemeral portion. As used herein, an “ephemeral portion” or “non-persistent portion” of a configuration state refers to any commands (and associated data) that do not persist when a network device experiences a power loss event. For example, where a network device experiences a power loss event such as losing power, disconnecting, going down, rebooting, or for any reason, an ephemeral portion of the configuration state is deleted or otherwise discarded when the network device goes down, is rebooted, or otherwise re-commences operation. In contrast, a “non-ephemeral portion” or “persistent portion” of a configuration state may refer to any commands that persist when a network device experiences a power down or reboot event. For example, where a network device loses power, becomes disconnected, goes down, or reboots for any reason, a non-ephemeral portion of a configuration state is restored and implemented as the network device re-commences operation.

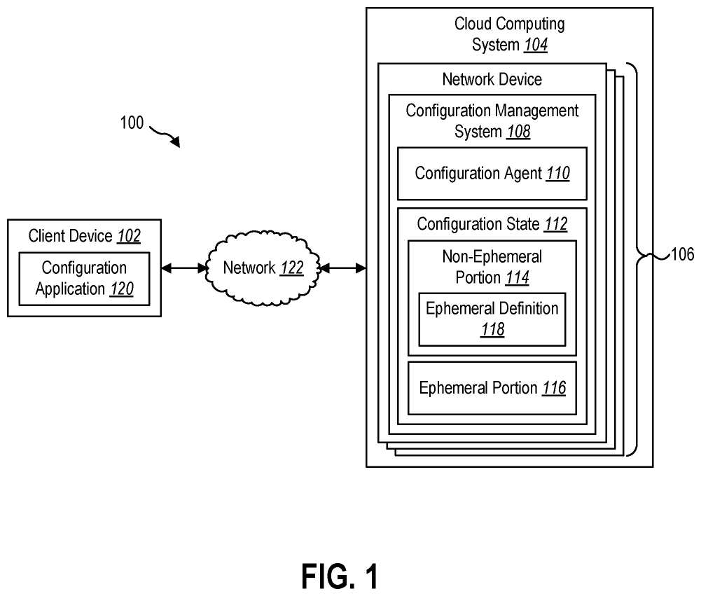

Additional detail will now be provided regarding a configuration management system in relation to illustrative figures portraying example implementations. For example, FIG. 1 illustrates an example environment 100 including a client device 102 and a cloud computing system 104. The cloud computing system 104 may include any number of network devices 106. In accordance with one or more embodiments described herein, the network devices 106 may include a wide variety of different types of network devices having different capabilities and configuration states implemented thereon. Moreover, while one or more implementations described herein are discussed specifically in connection with a cloud computing system, features and functionality described in connection with network devices of a cloud computing system may similarly apply to any network device within a variety of networks.

To illustrate, FIG. 1 shows a network device of the plurality of network devices 106 that includes a configuration management system 108 implemented thereon. It will be appreciated that each of the network devices 106 may similarly include a configuration management system thereon having features and functionality that are unique to each of the respective network devices 106. Nevertheless, while the network devices 106 may have different configuration states having different ephemeral and non-ephemeral characteristics implemented thereon, features discussed in connection with the illustrated network device having the configuration management system 108 broadly apply to each of the network devices 106 of the cloud computing system 104.

As shown in FIG. 1, the configuration management system 108 may include a configuration agent 110 and a configuration state 112. As discussed above, the configuration state 112 may include a non-ephemeral portion 114 and an ephemeral portion 116. As further shown, the configuration state 112 may include an ephemeral definition 118 within the non-ephemeral portion 114. As mentioned above, each of the network devices 106 may include similar components 110-118 of the configuration management system 108 implemented thereon. As further shown, the client device 102 may include a configuration application 120.

Each of the client device 102 and network devices 106 of the cloud computing system 104 may communicate with one another via a network 122. The network 122 may include one or multiple networks that use one or more communication platforms or communication technologies for transmitting data. For example, the network 122 may include the internet or other data link that enables transport of electronic device between the client device 102 and network devices 106 of the cloud computing system 104 as well as between respective network devices 106 of the cloud computing system 104.

As shown in FIG. 1, the configuration management system 108 includes a configuration agent 110. The configuration agent 110 may provide an interface for communicating with the network device. For example, the configuration agent 110 may provide an interface to communicate with or otherwise interface with the configuration application 120 on the client device 102. Similarly, the configuration application 120 may include an application associated with the configuration management system 108 that enables a user of the client device 102 to provide information to the configuration management system 108, such as an identification of one or more commands of the configuration state 112 that should be defined as ephemeral or non-ephemeral.

For example, the configuration agent 110 may expose a structure of the configuration state 112 to the configuration application 120 to enable the configuration application 120 to present a graphical user interface including a representation of the configuration state 112. A user may interact with a display of the configuration state 112 (e.g., a data model) or other representation of the configuration state 112 (e.g., a CLI) to identify or otherwise provide information to the configuration management system 108 pointing to selective portions of the configuration state 112. Based on this information, the configuration management system 108 may define respective portions of the configuration state 112 as within the ephemeral portion 116 or the non-ephemeral portion 114 of the configuration state 112.

In addition to interacting with the configuration application 120 and facilitating selective identification of portions of the configuration state 112, the configuration agent 110 may additionally implement policies defined by commands of the configuration state 112. For example, where a command and/or sub-command of the configuration state 112 indicates a particular protocol that is restricted, the configuration agent 110 may prevent information packets having the particular protocol from being transmitted, relayed, or otherwise received by the network device. As another example, where the configuration state 112 indicates a select list of internet protocol (IP) addresses that are trusted for access to the network device, the configuration agent 110 may implement policies that prevent other devices from accessing data and/or resources of the network device.

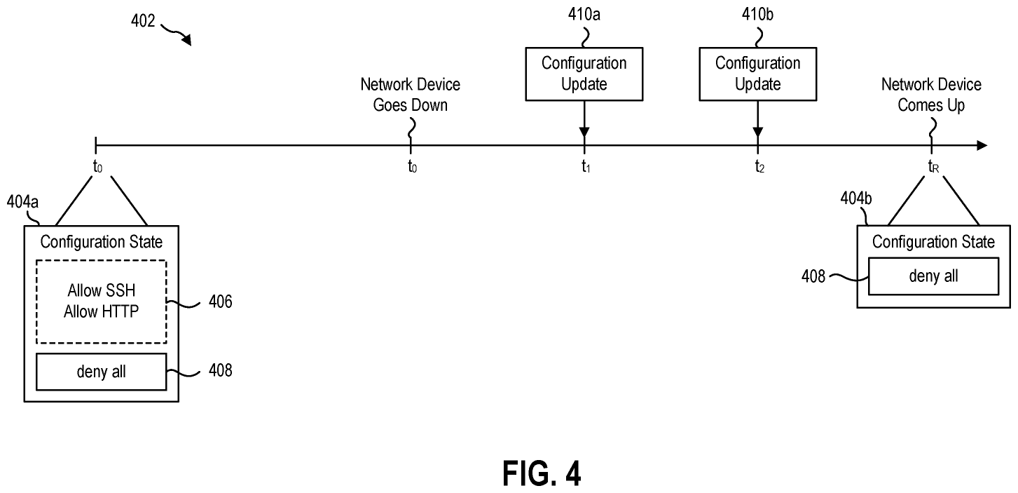

In one or more embodiments, the configuration agent 110 implements a startup configuration. For example, upon performing a reboot, the configuration agent 110 may call a startup configuration to determine how to startup the network device. In one or more embodiments described herein, the configuration agent 110 implements a startup configuration that restores a non-ephemeral portion 114 of the configuration state 112 without restoring the ephemeral portion 116 of the configuration state 112. In one or more implementations, and as will be discussed further in connection with FIG. 4 below, upon receiving a current version of the configuration state 112, the configuration agent 110 may restore a current configuration state 112 including both an updated non-ephemeral portion 114 and an updated ephemeral portion 116.

As mentioned above, and as shown in FIG. 1, the configuration state 112 may include both a non-ephemeral portion 114 and an ephemeral portion 116 as defined by an ephemeral definition 118. In particular, in one or more embodiments described herein, the configuration state 112 may include a listing of commands in which the ephemeral nature of the specific commands and sub-commands are identified by the ephemeral definition 118. Thus, the configuration state 112 may include both the non-ephemeral portion 114 and the ephemeral portion 116 within the same datastore on or otherwise accessible to the network device.

The ephemeral definition 118 may include a listing of commands identified by keywords, XPaths, modes, or any other identifier that may be used to point to one or more lines or commands of the configuration state 112. For example, the ephemeral definition 118 may include a listing of keywords that point to specific protocols, devices, device locations (e.g., virtual or physical locations), interfaces, or other characteristics of the respective commands to include within an ephemeral portion 116 of the configuration state 112. In one or more embodiments, the ephemeral definition 118 may include a list of metadata identifiers that may similarly be used to point to specific commands of the configuration state 112 to be defined within the ephemeral portion 116 of the configuration state 112.

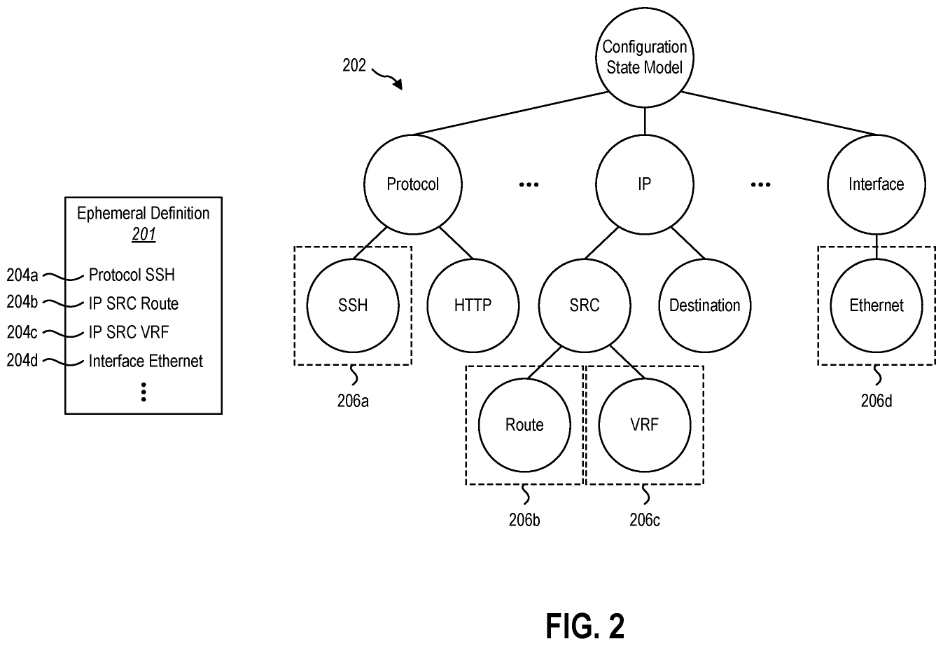

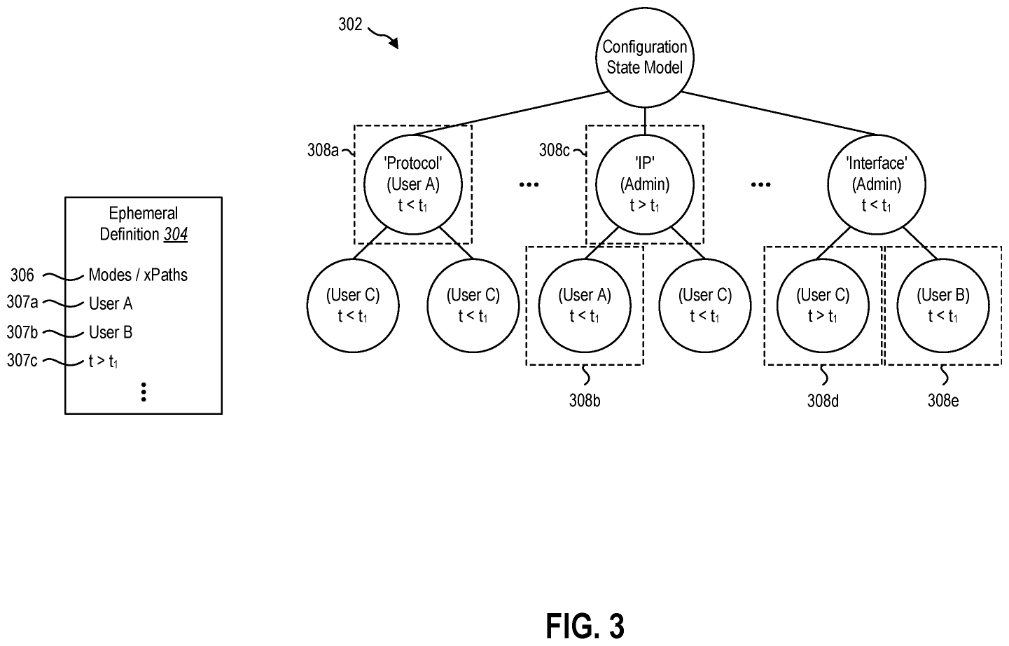

In one or more embodiments, the ephemeral definition 118 is included within the configuration state 112 (e.g., within the non-ephemeral portion 114). In one or more implementations, modifications or changes to the ephemeral definition 118 may be made without modifying the specific commands or subcommands of the configuration state 112. Additional detail in connection with the respective portions 114-116 of the configuration state 112 and the ephemeral definition 118 is discussed below by way of example in connection with FIGS. 2-3.

FIG. 2 illustrates an example implementation of an ephemeral definition 201 that may be created and used to selectively identify commands and associated sub-commands to be defined within the ephemeral portion 116 of the configuration state 112 for a network device. In particular, FIG. 2 illustrates a configuration tree 202 showing a visual representation of the configuration state 112. The configuration tree 202 can include any number of command nodes organized using any number of levels in which command nodes at lower levels of the tree identify more specific features and characteristics of the respective commands of the configuration state 112 than higher level command nodes.

While the configuration tree 202 may include any number of branches having any number of layers, for ease in explanation, the illustrated configuration tree 202 shows three branches having respective sub-branches with each incremental level of the configuration tree 202. Each of the command nodes may have any number of branches connecting a command node to sub-nodes of a next level of the configuration tree 202. For example, a command node may include a single branch (or no branches, if the command node is the last level of a particular path) or several hundred or thousands of branches. Accordingly, the example shown in FIG. 2 is provided by way of example and not limitation.

As shown in FIG. 2, the configuration tree 202 includes a first branch of command nodes named “protocol.” This branch of the configuration tree 202 may include commands that govern protocols that may be used in receiving and/or transmitting information packets from the network device. More specifically, this branch of the configuration tree 202 may affect any command that references or includes a keyword (e.g., a mode or XPath) of “protocol.” For example, the “protocol” command node may include several sub-branches indicating protocols such as Secure Shell (SSH) protocol and Hypertext Transfer Protocol (HTTP) that the network device is permitted to use in communicating data to and from the network device. Where these are the only two permissible protocols, the network device may block or otherwise prevent communication of other types of protocols via the network device to other devices within or outside the cloud computing system 104.

As further shown, the configuration tree 202 includes a second branch of command nodes named “IP.” This branch of the configuration tree 202 may include any commands that reference or include a keyword (e.g., a mode or XPath) of “IP.” For example, this branch of the configuration tree 202 may include commands that govern source IP addresses and/or destination IP addresses with which the network device is permitted to communicate. Further, this branch of the configuration tree 202 may indicate specific types of commands (e.g., route commands, forwarding commands) that are permitted or accessible to the network device in connection with specific IP addresses.

As further shown, the configuration tree 202 includes a third branch of command nodes named “Interface.” Similar to the other branches, this branch may include any commands that reference or include a keyword (e.g., a mode or XPath) of “Interface.” For example, this branch of the configuration tree may include commands or rules that govern which interfaces or types of interfaces (e.g., Ethernet) may be used by the network device in receiving and/or transmitting information packets.

As shown in FIG. 2, the ephemeral definition 201 may include a listing of command identifiers. For example, the ephemeral definition 201 may include a first command identifier 204a named “Protocol SSH” which points to a first portion 206a of the configuration tree 202. The ephemeral definition 201 may further include a second command identifier 204b named “IP SRC Rout” which points to a second portion 206b of the configuration tree 202. The ephemeral definition 201 may further include a third command identifier 204c named “IP SRC VRF” which points to a third portion 206c of the configuration tree 202. The ephemeral definition 201 may also include a fourth command identifier 204d named “Interface Ethernet” which points to a fourth portion 206d of the configuration tree 202. The ephemeral definition 201 may include any number of command identifiers that point to specific commands or sub-commands of the configuration tree 202.

As shown in FIG. 2, each of the identified portions 206a-d of the configuration tree 202 includes a command node indicated by a corresponding command identifier and any additional sub-nodes or lower level branches that extend from the indicated command node. For example, the first portion 206a identified by the first command identifier 204a includes the “SSH” command node and all lower level nodes extending therefrom. The second portion 206b identified by the second command identifier 204b includes the “route” command node and all lower level nodes extending therefrom. The third portion 206c identified by the third command identifier 204c includes the “VRF” command node and all lower level nodes extending therefrom. The fourth portion 206d identified by the fourth command identifier 205d includes the “Ethernet” command node and all lower level nodes extending therefrom. Identifying the respective portions 206a-d in this way enables a manageable data object to function as the ephemeral definition 201 without implementing an involved and time-consuming modification of a configuration state, such as in conventional systems where ephemeral and non-ephemeral portions of a configuration state are stored on separate datastores.

In this example shown in FIG. 2, the command identifiers 204a-d include a set of keywords that identify a specific path of command nodes as they branch off from the root node named “Configuration State Model,” referencing the model for the configuration state as a whole. While one or more embodiments may require a full path to correctly point to a specific command node, in one or more embodiments, only the specific command node (e.g., a single keyword rather than a full path of the configuration tree 202) may be identified by the command identifier and any command node having that name may be included within the ephemeral portion 116 of the configuration state 112.

Moreover, as mentioned above, the command identifiers 304a-d may include a variety of identifier types depending on a type of model used to represent the configuration state 112. For example, where the configuration state 112 is represented by a CLI, the command identifiers may be an identifier of a mode. In particular, the command identifier may include a single or series of multiple keywords that identify a corresponding mode. As an illustrative example, a set of CLI-based command identifiers may be listed (e.g., within an ephemeral definition) as follows:
Ip vrf // no vrf configuration is persisted
Ip route // no route configuration is persisted
Interface Ethernet 12/1 // no configuration for this interface is persisted
Interface Ethernet 13/1 // no configuration for this interface is persisted
   In this example, listed commands may be defined as within the ephemeral portion 116 of the configuration state 112. Further, listed partial commands may indicate that commands starting with the provided partial command are not persisted. Thus, any commands that branch off from an indicated command are also not persisted.

As another example, where the configuration state 112 is represented by a data model, the command identifiers may be an identifier of a particular XPath (or other type of data) within the data model. Similar to the CLI-based model, command identifiers for a data model may include one or multiple keywords that point to one or multiple command nodes to be defined as within the ephemeral portion 116 of the configuration state 112. As an illustrative example, a set of command identifiers may be listed (e.g., within an ephemeral definition) as follows.
/ip/vrf // no vrf configuration is persisted
/ip/route/destination[starts-with(.‘100’)] // routes starting with “100” are not persisted
   The above-listing associated with the data model may be formalized in a number of ways within an ephemeral definition. For example, the above-list of command identifiers may be formally defined using a YANG model listed as follows:

List ephemeral {

key xpath;
leaf xpath {

type xpath1.0;

}

}

This example may further be encoded in JSON as follows:

“ephemeral” : [

{ “xpath”: “/ip/vrf” }
{“xpath” : “/ip/route/destination[starts-with(., ‘100.’)]}

]

FIG. 3 illustrates another example implementation of an ephemeral definition 304 that may be created and used to selectively identify commands and associated sub-commands to be defined within the ephemeral portion 116 of the configuration state 112 for a network device. In particular, FIG. 3 illustrates a configuration tree 302 showing a visual representation of the configuration state 112. The configuration tree 302 may include any number of command nodes and may share some or all of the same features as the configuration tree 202 discussed above in connection with FIG. 2. For example, the command nodes of the configuration tree 302 may include names (e.g., protocols, IP, Interface) for each of the command nodes similar to those discussed above in connection with FIG. 2. Moreover, while not explicitly discussed above in connection with FIG. 2, the configuration tree 202 of FIG. 2 may similarly include some or all of the same features as the configuration tree 302 shown in FIG. 3 and discussed herein.

As shown in FIG. 3, each of the command nodes may have associated metadata that provides unique information about each of the command nodes. For example, on a first branch of the configuration tree 202, a “Protocol” command node may include metadata indicating that “User A” created the command node, added or removed a characteristic of the command node, designated the command node as ephemeral, or otherwise modified the command node in some way. Indeed, the “Protocol” command node could include metadata about any or all of the above modifications to the command node. The command node may further include a timestamp of a latest modification or multiple timestamps according to multiple modifications over time. For example, in the illustrated example, the “Protocol” command mode includes metadata indicating that a latest or most recent modification was made to the command mode prior to time t₁, with t₁ being an arbitrary time referenced by a metadata identifier within the ephemeral definition 304 (discussed below).

As further shown, an “IP” command node on a second branch of the configuration tree 202 includes metadata indicating that “Admin” modified the command node in some way (e.g., created, added or removed a characteristic, designated the command mode as ephemeral). The command node further includes metadata indicating that a latest modification to the command node was performed at a time after time t₁. Also shown, the “Interface” command node on a third branch of the configuration tree 202 includes metadata indicating that “Admin” modified the command node in some way. The command node further includes metadata indicating that a latest modification to the command node was performed at a time prior to time t₁. Each of the lower level command nodes have similar types of metadata indicating modifications made by a variety of users (e.g., “User A,” “User B,” “Admin”) and at different times relative to time t₁.

As shown in FIG. 3, the ephemeral definition 304 may include a listing of identifiers. For example, the ephemeral definition 304 may have any number of command identifiers 306 (e.g., Modes, XPaths) having characteristics corresponding to a format or unique structure of the configuration tree 302. For example, the command identifiers 306 may include identifiers that reference modes or XPaths depending on whether the configuration tree 302 is representative of a CLI-based model or a data model, respectively. In one or more embodiments, the command identifiers 306 include a combination of different types of identifiers where the different types of identifiers are capable of identifying different command nodes across different types of configuration state formats (e.g., a generic command identifier capable of pointing to command nodes in different model representations of a configuration state).

In addition to the command identifiers 306 that reference specific command nodes and any additional command nodes that depend therefrom, the ephemeral definition 304 may further include metadata identifiers 307a-c that reference different types of metadata. For example, the ephemeral definition 304 may include a first metadata identifier 307a associated with command nodes modified by “User A.” As further shown, the ephemeral definition 304 may include a second metadata identifier 307b associated with command nodes modified by “User B.” As further shown, the ephemeral definition 304 may include a third metadata identifier 307c indicating a reference time t₁ or, more specifically, a range of all timestamps after the reference time t₁.

When added to or otherwise included within the ephemeral definition 304, the metadata identifiers 307a-c may reference specific metadata that causes a corresponding command node to be included within the ephemeral portion 116 of the configuration state 112. In particular, where a command node has a corresponding type or value of metadata that fits within or matches a value of a corresponding metadata identifier, the command node may be defined as within the ephemeral portion 116 of the configuration state. By associating metadata identifiers with command nodes in this way, the ephemeral definition 304 provides additional flexibility in selectively identifying individual command nodes, multiple command nodes, or select portions of the configuration tree 302 to be included within the ephemeral portion 116 of the configuration state 112.

As shown in FIG. 3, one or more of the metadata identifiers 307a-c may reference individual or multiple ephemeral nodes 308a-e within the configuration tree 302 to be included within the ephemeral portion 116 of the configuration state 112. For example, a first ephemeral node 308a may be designated as ephemeral based on “User A” having modified the command node most recently. While lower level command nodes to the first ephemeral node 308a are not explicitly indicated as ephemeral as a result of the metadata of the first ephemeral node 308a being referenced by the first metadata identifier 307a, lower level command nodes may or may not be similarly indicated as ephemeral based on metadata identifiers that correspond to higher level nodes within the same branch of the configuration tree 302.

As further shown, a second ephemeral node 308b may be designated as ephemeral based on “User A” having modified the command node most recently (e.g., based on the first metadata identifier 307a). A third ephemeral node 308c may be designated as ephemeral based on a latest modification to the command mode being made after time t₁ (e.g., based on the third metadata identifier 307c). A fourth ephemeral node 308d may be designated as ephemeral based on a latest modification to the command mode being made after time t₁ (e.g., based on the third metadata identifier 307c). A fifth ephemeral node 308e may be designated as ephemeral based on “User B” having modified the command node most recently (e.g., based on the second metadata identifier 307b).

FIG. 4 illustrates an example timeline 402 illustrating the state of an ephemeral and non-ephemeral portion of a configuration state prior to a network device going down and after performing a reboot of a network device. In particular, FIG. 4 illustrates a timeline 402 beginning at time t₀ which may refer to any time prior to when the network device goes down (shown as t_{D}). At time t₀, a configuration state 404a may include an ephemeral portion 406 and a non-ephemeral portion 408. In this example, the non-ephemeral portion 408 may correspond to a restrictive configuration in which permissions and access to the network device are limited or at a higher level of security as when the configuration state 404a includes both the ephemeral portion 406 and non-ephemeral portion 408.

As shown in FIG. 4, the initial configuration state 404a includes a listing of keywords (e.g., modes, XPaths) indicating types of protocols that a network device is permitted to use. For example, within the ephemeral portion 406, the configuration state 404a includes identified configuration commands that read “allow ssh” and “allow http.” These commands may indicate that communications having protocols of SSH or HTTP should be permitted by the network device. As further shown, a non-ephemeral portion 408 of the configuration state 404a includes a configuration command of “deny all,” which indicates that all other communication protocols not specified within the ephemeral portion 406 should be blocked or otherwise not permitted by the network device.

As shown in FIG. 4, at time t_{D}, the network device may go down or otherwise experience some power loss event. In response to the network device going down, the configuration management system 108 maintains or persists the non-ephemeral portion 408 (e.g., within a non-volatile memory of the network device) while losing, discarding, or simply not attempting to persist the ephemeral portion 406 of the configuration state 404a.

As shown on the timeline 402, one or more configuration updates 410a-b may be made to the configuration state. However, because the network device is down, the network device may fail to receive or register the configuration updates 410a-b corresponding to times t₁ and t₂. For example, one or more of the updates 410a-b may include an addition of one or more additional protocols that the network device is permitted to use in communicating with other devices. Alternatively, one or more of the updates 410a-b may include removal of one of the allowed protocols (e.g., the SSH protocol) from the permitted list of protocols defined within the ephemeral portion 406 of the configuration state 404a prior to the network device going down.

Because the network device may not have up to date configuration information on coming up at time t_{R}, the configuration management system 108 may revert to a reboot configuration state 404b including only the non-ephemeral portion 408 of the initial configuration state 404a. In one or more embodiments, the reboot configuration state 404b refers to a more restrictive configuration state than the initial configuration state 404a prior to the network device going down. The reboot configuration state 404b may refer to a default or initial configuration state for a new network device before any permissions have been granted. As used herein, a “reboot configuration state” may refer a configuration state of the network device upon resetting, rebooting, bringing a network device back up, or otherwise recovering from a power loss event.

While the network device may simply continue operating at the reboot configuration state 404b indefinitely, in one or more embodiments, the network device operates in accordance with the reboot configuration state 404b only until a current version of the configuration state and/or ephemeral definition is provided to the network device. For example, upon performing the reboot, the network device may provide a request to a central repository or other network device having access to current configuration state information and/or ephemeral definitions for various devices. In response to the request, the network device may receive a current configuration state or current version of the ephemeral definitions including information associated with one or more updates (e.g., configuration updates 410a-b). Receiving this information after reboot may enable the network device to implement a current version of the ephemeral portion of the configuration state after performing the reboot.

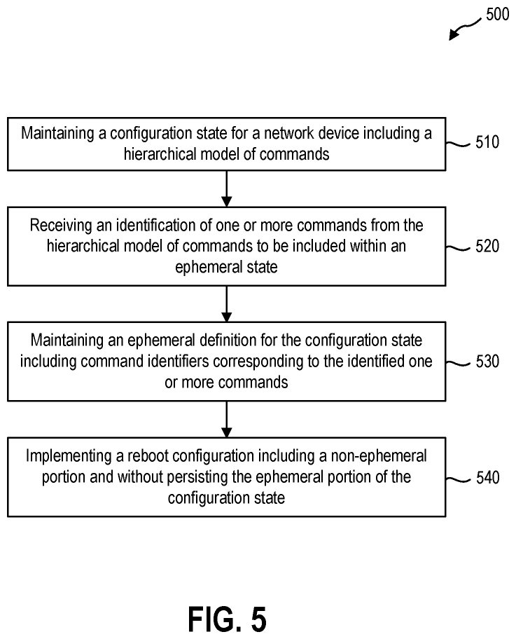

Turning now to FIG. 5, this figure illustrates an example flowchart including series of acts for defining and implementing an ephemeral portion of a configuration state on a network device. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device (e.g., input device, gaming console, client device) to perform the acts of FIG. 5. In still further embodiments, a system can perform the acts of FIG. 5.

FIG. 5 illustrates a series of acts 500 related to defining an ephemeral portion of a configuration state for a network device. As shown in FIG. 5, the series of acts 500 includes an act 510 of maintaining a configuration state for a network device including a hierarchical model of commands. In one or more implementations, the act 510 includes maintaining a configuration state for a network device where the configuration state includes a hierarchical model of commands including characteristics associated with operation of the network device on a network of computing devices. In one or more implementations, the network device includes one or more of a router, a switch, a firewall, or a load balancer on a network of computing devices where the network device is configured to communicate information packets between computing nodes on the network of computing devices.

As further shown, the series of acts 500 includes an act 520 of receiving an identification of one or more commands from the hierarchical model of commands to be included within an ephemeral state. In one or more implementations, the act 520 includes receiving an identification of one or more commands from the hierarchical model of commands to be included within an ephemeral portion of the configuration state.

In one or more implementations, the hierarchical model of commands includes an extensible markup language (XML) data model instantiation where the identification of the one or more commands includes one or more XPaths. Further, in one or more implementations, receiving the identification of the one or more commands includes receiving one or more keywords via a command line interface (CLI) where the one or more keywords indicate the one or more commands from the hierarchical model of commands to be included within the ephemeral portion of the configuration state.

As further shown, the series of acts 500 includes an act 530 of maintaining an ephemeral definition for the configuration state including command identifiers corresponding to the identified one or more commands. In one or more implementations, the act 530 includes maintaining an ephemeral definition for the configuration state where the ephemeral definition includes command identifiers corresponding to the identified one or more commands. The one or more commands and any corresponding sub-commands may be designated as part of the ephemeral portion of the configuration state based on the command identifiers being associated with the one or more commands.

In one or more implementations, the command identifiers include an identification of one or more Internet Protocol (IP) addresses with which the network device is permitted to communicate. In addition, in one or more embodiments, the command identifiers include an identification of one or more communication protocols that the network device is permitted to use in communicating information packets.

As further shown, the series of acts 500 includes an act 540 of implementing a reboot configuration including a non-ephemeral portion and without persisting the ephemeral portion of the configuration state. In one or more implementations, the act 540 includes, in response to experiencing a power loss event by the network device, implementing a reboot configuration state including a non-ephemeral portion of the configuration state and without persisting the ephemeral portion of the configuration state. In one or more implementations, implementing the reboot configuration state includes restoring a default configuration state including a more restrictive set of commands than the hierarchical model of commands including the ephemeral portion and associated with operation of the network device prior to experiencing the power loss event.

The series of acts 500 may further include receiving a metadata identifier indicating one or more characteristics of at least one command from the hierarchical model of commands. The series of acts 500 may further include updating the ephemeral definition to include the metadata identifier where the metadata identifier designates any commands from the hierarchical model of commands having a set of characteristics that match the metadata identifier as part of the ephemeral portion of the configuration state. The metadata identifier may indicate one or more of a user who created a command, a user who modified the command, a time when the command was created, and a time when the command was modified.

In one or more implementations, the series of acts 500 includes receiving, after experiencing the power loss event, information associated with an updated configuration state for the network device. Further, the series of acts 500 may include updating the ephemeral definition for the reboot configuration state to include an updated ephemeral portion corresponding to the information associated with the updated configuration state for the network device.

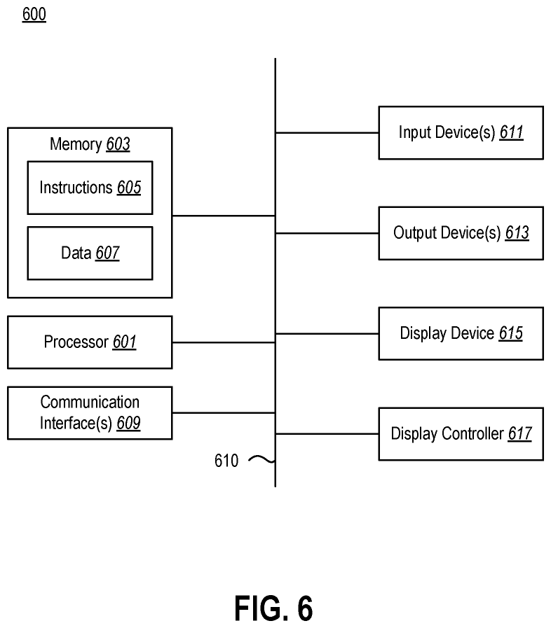

FIG. 6 illustrates certain components that may be included within a computer system 600. One or more computer systems 600 may be used to implement the various devices, components, and systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and light pen (or light-sensitive wand). Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
maintaining a configuration state for a network device, the configuration state including a hierarchical model of commands including characteristics associated with operation of the network device on a network of computing devices;
receiving an identification of one or more commands from the hierarchical model of commands to be included within an ephemeral portion of the configuration state;
maintaining an ephemeral definition for the configuration state, the ephemeral definition including command identifiers corresponding to the identified one or more commands, wherein the one or more commands and any corresponding sub-commands are designated as part of the ephemeral portion of the configuration state based on the command identifiers being associated with the one or more commands; and
in response to experiencing a power loss event by the network device, implementing a reboot configuration state including a non-ephemeral portion of the configuration state and without persisting the ephemeral portion of the configuration state.

2. The method of claim 1, wherein the hierarchical model of commands includes an extensible markup language (XML) data model instantiation, and wherein the identification of the one or more commands includes one or more XPaths.

3. The method of claim 1, wherein receiving the identification of the one or more commands comprises receiving one or more keywords via a command line interface (CLI), the one or more keywords indicating the one or more commands from the hierarchical model of commands to be included within the ephemeral portion of the configuration state.

4. The method of claim 1, wherein the command identifiers include an identification of one or more Internet Protocol (IP) addresses with which the network device is permitted to communicate.

5. The method of claim 1, wherein the command identifiers include an identification of one or more communication protocols that the network device is permitted to use in communicating information packets.

6. The method of claim 1, wherein the network device includes one or more of a router, a switch, a firewall, or a load balancer on a network of computing devices, the network device being configured to communicate information packets between computing nodes on the network of computing devices.

7. The method of claim 1, further comprising:
receiving a metadata identifier indicating one or more characteristics of at least one command from the hierarchical model of commands; and
updating the ephemeral definition to include the metadata identifier, wherein the metadata identifier designates any commands from the hierarchical model of commands having a set of characteristics that match the metadata identifier as part of the ephemeral portion of the configuration state.

8. The method of claim 7, wherein the metadata identifier indicates one or more of:
a user who created a command;
a user who modified the command;
a time when the command was created; or
a time when the command was modified.

9. The method of claim 1, wherein implementing the reboot configuration state comprises restoring a default configuration state including a more restrictive set of commands than the hierarchical model of commands including the ephemeral portion and associated with operation of the network device prior to experiencing the power loss event.

10. The method of claim 1, further comprising:
receiving, after experiencing the power loss event, information associated with an updated configuration state for the network device; and
updating the ephemeral definition for the reboot configuration state to include an updated ephemeral portion corresponding to the information associated with the updated configuration state for the network device.

11. A system, comprising:
one or more processors;
a memory in electronic communication with the one or more processors; and
instructions stored in the memory, the instructions being executable by the one or more processors to:
maintain a configuration state for a network device, the configuration state including a hierarchical model of commands including characteristics associated with operation of the network device within a network of computing devices;
receive an identification of one or more commands from the hierarchical model of commands to be included within an ephemeral portion of the configuration state;
maintain an ephemeral definition for the configuration state, the ephemeral definition including command identifiers corresponding to the identified one or more commands, wherein the one or more commands and any corresponding sub-commands are designated as part of the ephemeral portion of the configuration state based on the command identifiers being associated with the one or more commands; and
in response to experiencing a power loss event by the network device, implement a reboot configuration state including a non-ephemeral portion of the configuration state and without persisting the ephemeral portion of the configuration state.

12. The system of claim 11, wherein the hierarchical model of commands includes an extensible markup language (XML) data model instantiation, and wherein the identification of the one or more commands includes one or more XPaths.

13. The system of claim 11, wherein receiving the identification of the one or more commands comprises receiving one or more keywords via a command line interface (CLI), the one or more keywords indicating the one or more commands from the hierarchical model of commands to be included within the ephemeral portion of the configuration state.

14. The system of claim 11,
wherein the command identifiers include an identification of one or more Internet Protocol (IP) addresses with which the network device is permitted to communicate, and
wherein the command identifiers include an identification of one or more communication protocols that the network device is permitted to use in communicating information packets.

15. The system of claim 11, further comprising instructions being executable by the one or more processors to:
receive a metadata identifier indicating one or more characteristics of at least one command from the hierarchical model of commands, the metadata identifier indicating one or more of a user who created a command, a user who modified the command, a time when the command was created, or a time when the command was modified; and
update the ephemeral definition to include the metadata identifier, wherein the metadata identifiers designate any commands from the hierarchical model of commands having a set of characteristics that match the metadata identifier as part of the ephemeral portion of the configuration state.

16. A non-transitory computer readable medium storing instructions thereon that, when executed by one or more processors, causes a network device to:
maintain a configuration state for the network device, the configuration state including a hierarchical model of commands including characteristics associated with operation of the network device on a network of computing devices;
receive an identification of one or more commands from the hierarchical model of commands to be included within an ephemeral portion of the configuration state;
maintain an ephemeral definition for the configuration state, the ephemeral definition including command identifiers corresponding to the identified one or more commands, wherein the one or more commands and any corresponding sub-commands are designated as part of the ephemeral portion of the configuration state based on the command identifiers being associated with the one or more commands; and
in response to experiencing a power loss event by the network device, implement a reboot configuration state including a non-ephemeral portion of the configuration state and without persisting the ephemeral portion of the configuration state.

17. The non-transitory computer readable medium of claim 16, wherein the hierarchical model of commands includes an extensible markup language (XML) data model instantiation, and wherein the identification of the one or more commands includes one or more XPaths.

18. The non-transitory computer readable medium of claim 16, wherein receiving the identification of the one or more commands comprises receiving one or more keywords via a command line interface (CLI), the one or more keywords indicating the one or more commands from the hierarchical model of commands to be included within the ephemeral portion of the configuration state.

19. The non-transitory computer readable medium of claim 16,
wherein the command identifiers include an identification of one or more Internet Protocol (IP) addresses with which the network device is permitted to communicate, and
wherein the command identifiers include an identification of one or more communication protocols that the network device is permitted to use in communicating information packets.

20. The non-transitory computer readable medium of claim 16, further comprising instructions thereon that, when executed by the one or more processors, causes the network device to:
receive a metadata identifier indicating one or more characteristics of at least one command from the hierarchical model of commands, the metadata identifier indicating one or more of a user who created a command, a user who modified the command, a time when the command was created, or a time when the command was modified; and
update the ephemeral definition to include the metadata identifier, wherein the metadata identifiers designate any commands from the hierarchical model of commands having a set of characteristics that match the metadata identifier as part of the ephemeral portion of the configuration state.
